(19) United States
(12) Patent Application Publication
(10) Pub. No.: US 2018/0367653 A1
(43) Pub. Date: Dec. 20, 2018

(54) Charger Cord Support System

(71) Applicant: Michael Sweney, Johnstown, CO (US)

(72) Inventor: Michael Sweney, Johnstown, CO (US)

(21) Appl. No.: 15/627,884

(22) Filed: Jun. 20, 2017

(51) Int. Cl. H04M 1/02; H01R 13/60; H01R 31/06

(52) U.S. Cl. CPC H04M 1/02; H01R 13/60; H01R 31/00; B65H 2701/3919; H01R 31/06

(57) ABSTRACT

A charger cord support system for enhancing a service life of a charge cord includes a charge cord that is electrically coupled to an electronic device. A plug is electrically coupled to the charge cord. A support is positioned around the charge cord and the plug. The support is comprised of a resiliently flexible material such that the support inhibits the charge cord from bending on the plug thereby enhancing a service life of the charge cord.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to support devices and more particularly pertains to a new support device for enhancing a service life of a charge cord.

### BRIEF SUMMARY OF THE INVENTION

An embodiment of the disclosure meets the needs presented above by generally comprising a charge cord that is electrically coupled to an electronic device. A plug is electrically coupled to the charge cord. A support is positioned around the charge cord and the plug. The support is comprised of a resiliently flexible material such that the support inhibits the charge cord from bending on the plug thereby enhancing a service life of the charge cord.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a charger cord support system according to an embodiment of the disclosure.

FIG. 2 is a front view of an embodiment of the disclosure.

FIG. 3 is a top view of an embodiment of the disclosure.

FIG. 4 is a right side view of an embodiment of the disclosure.

FIG. 5 is a perspective in-use view of an embodiment of the disclosure.

### DETAILED DESCRIPTION OF THE INVENTION

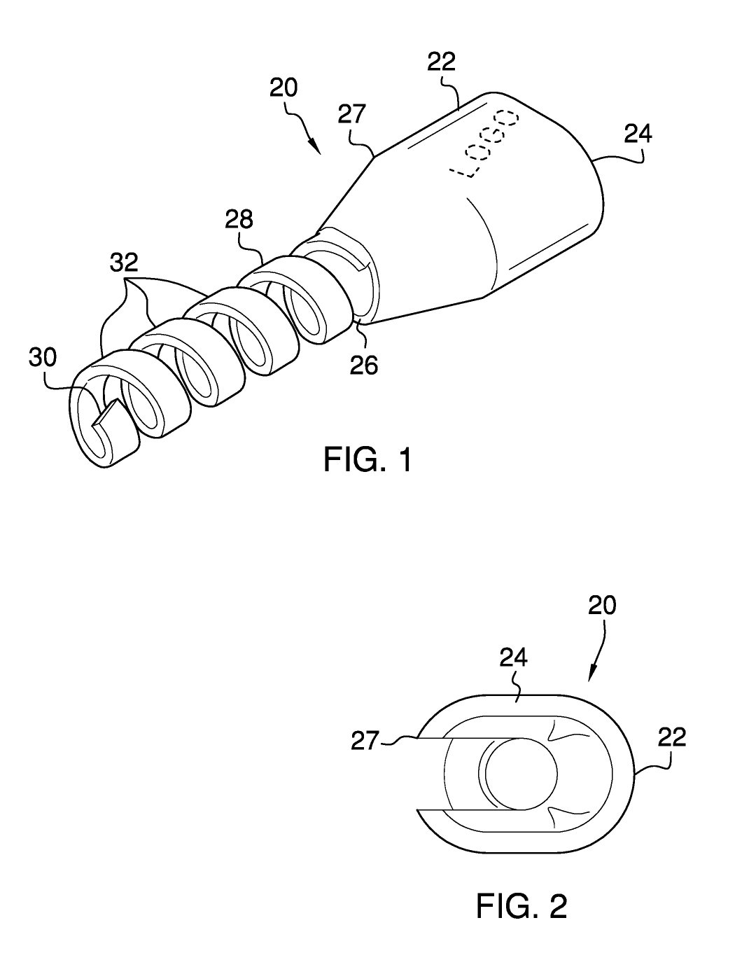

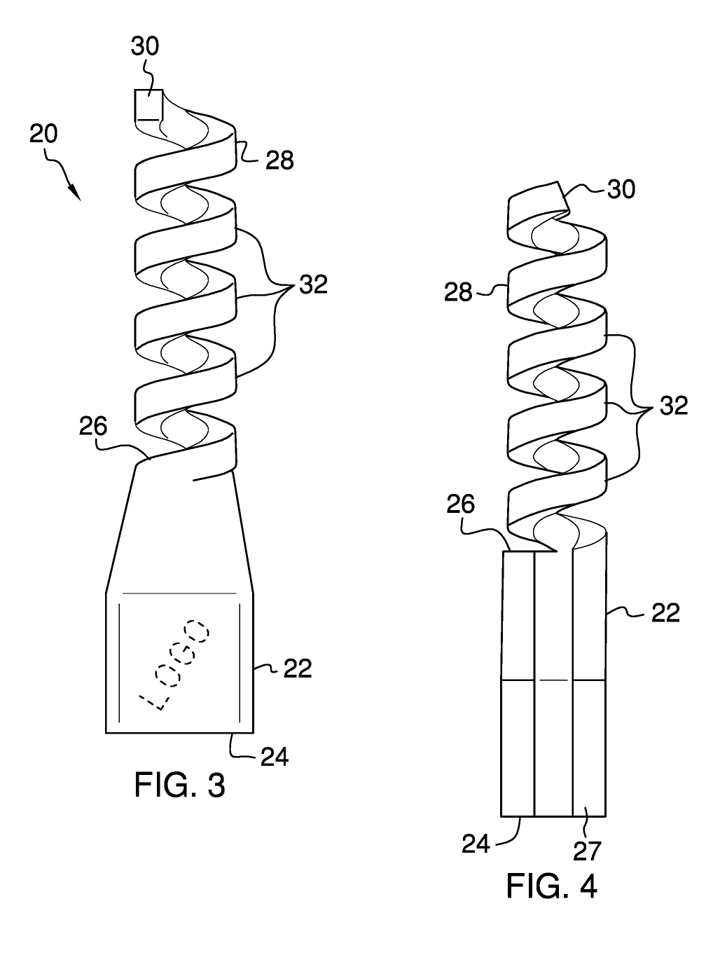

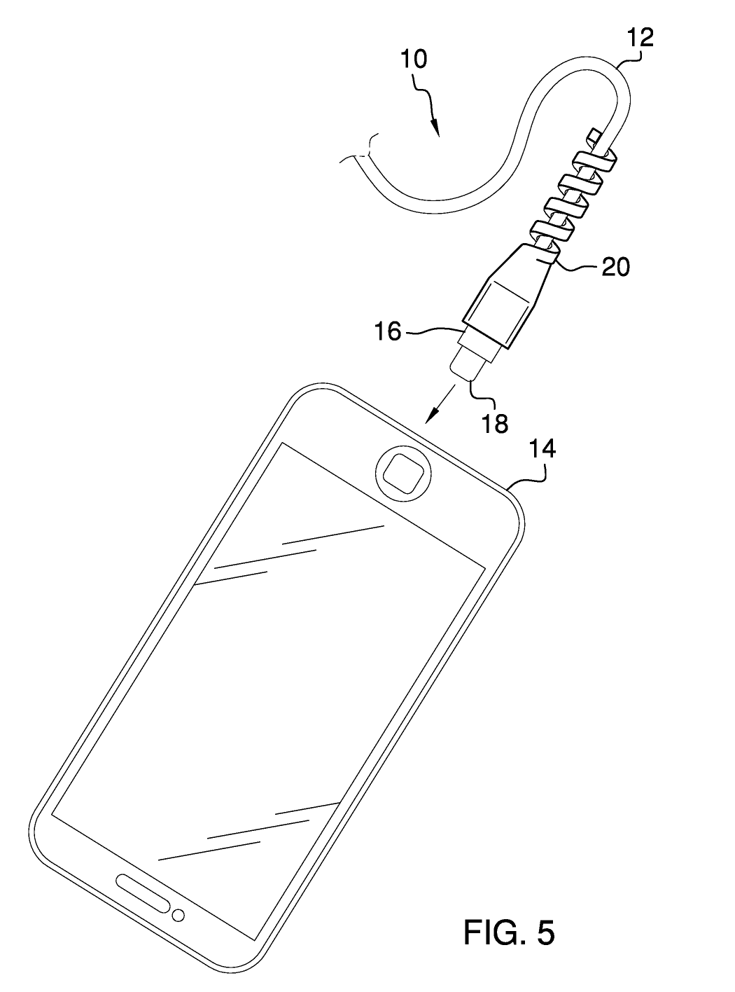

With reference now to the drawings, and in particular to FIGS. 1 through 5 thereof, a new support device embodying the principles and concepts of an embodiment of the disclosure and generally designated by the reference numeral 10 will be described.

As best illustrated in FIGS. 1 through 5, the charger cord support system 10 generally comprises a charge cord 12 that is electrically coupled to an electronic device 14. The electronic device 14 may be a smart phone, an I-pad, a laptop computer or any other electronic device 14 that has rechargeable batteries. A plug 16 is electrically coupled to the charge cord 12 and the plug 16 has a distal end 18 with respect to the charge cord 12. The charge cord 12 may be a usb charging cord and the plug 16 may be a micro usb plug, a lightning plug any other plug commonly used to charge batteries in an electronic device 14.

A support 20 is provided and the support 20 is selectively positioned around the charge cord 12 and the plug 16. The support 20 is comprised of a resiliently flexible material such that the support 20 inhibits the charge cord 12 from bending on the plug 16. In this way the support 20 enhances a service life of the charge cord 12 by reducing the likelihood of conductors in the cord from breaking due to repeated bending.

The support 20 comprises a box 22 that has a first end 24, a second end 26 and a first lateral side 27. Moreover, each of the first 24 and second 26 ends and the first lateral side 27 is open. A tail 28 is coupled to and extends away from the second end 26 and the tail 28 has a distal end 30 with respect to the box 22. The tail 28 is twisted into a plurality of coils 32. Moreover, the coils 32 are spaced apart from each other such that the tail 28 forms a helix extending between the second end 26 and the distal end 30 of the tail 28. Indicia may be printed on the box 22 and the indicia may comprise a selected logo and image.

In use, the charge cord 12 is positioned between the distal end 30 of the tail 28 and an adjacent coil 32 to the distal end 30 of the tail 28. Moreover, the tail 28 is rotated around the charge cord 12 until the charge cord 12 extends through an entire length of the helix. The plug 16 is extended through the first lateral side 27 of the box 22 and the plug 16 is positioned in the box 22 having the distal end 18 of the plug 16 extending outwardly through the first end 24. Thus, the distal end 18 of the plug 16 is exposed for plugging into the electronic device 14.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. (canceled)

2. (canceled)

3. (canceled)

4. (canceled)

5. A charger cord support system comprising:
a charge cord being configured to be electrically coupled to an electronic device, said charge cord having a plug being electrically coupled thereto, said plug having a distal end with respect to said charge cord; and
a support being positioned around said charge cord and said plug, said support being comprised of a resiliently flexible material such that said support inhibits said charge cord from bending on said plug thereby enhancing a service life of said charge cord, said support comprising:
a box having a first end and a second end, each of said first and second ends being open, and
a tail being coupled to and extending away from said second end, said tail having a distal end with respect to said box, said tail being twisted into a plurality of coils, said coils extending continuously in a direction away from said box and being spaced apart from each other such that said tail forms a helix extending between said second end and said distal end of said tail, a respective outermost surface of each said coil being linearly aligned and parallel to a respective innermost surface of said coil wherein said tail has a consistent diameter extending away from said box, said cord being inserted between said distal end of said tail and an adjacent coil to said distal end of said tail, said tail being rotated around said cord until said cord extends through an entire length of said helix and said plug is positioned in said box having said distal end of said plug extending outwardly through said first end.
